(19) United States
(12) Patent Application Publication
(10) Pub. No.: US 2014/0100911 A1
(43) Pub. Date: Apr. 10, 2014

(54) SYSTEM AND METHOD FOR ANALYZING THE SEQUENCES OF ACTIVITIES

(71) Applicant: Alex Elkin, Littleton, MA (US)

(72) Inventor: Alex Elkin, Littleton, MA (US)

(21) Appl. No.: 13/648,428

(22) Filed: Oct. 10, 2012

(51) Int. Cl. G06Q 10/06

(52) U.S. Cl. CPC G06Q 10/0633
USPC 705/7.27

(57) ABSTRACT

A system and method for analysis of sequences of facts is disclosed. The plurality of facts is extracted from one or more systems of record, the facts are converted to the time-ordered sequences, and then the sequences are converted into unique paths. A plurality of measures is calculated for each path. An operator can change the conversion rules and filter the paths, sequences and facts to be included in the analysis.

### FIELD OF THE INVENTION

The invention pertains to the field of business process analysis. More particularly, the invention pertains to the analysis of the actual execution of highly irregular, complex, and partially- or non-automated processes.

### DESCRIPTION OF RELATED ART

Operations of virtually any organization consist of multiple interrelated activities. In most cases these activities depend on each other either through a common resource such as a person or a machine which performs an activity or through a physical or logical object which is passed from resource to resource. For example, a mortgage application (object) is passed from a loan clerk (resource) to a mortgage officer (resource) once the loan clerk completes the necessary work on the application.

In order to provide better management and control of such activities, organizations developed rules which define the order in which the activities should be performed. Such rules are usually implemented in the form of computer programs which orchestrate the sequence of activities or just rely on people to follow them.

Analyzing the efficiency and quality of such processes has been the focus of inventors for a long time. The analytical methods can be divided into two main categories: process schema analysis and logs/patterns analysis.

Process schema analysis assumes the existence of the “perfect” process schema which describes the entire process from the beginning to the end. A schema could be defined by an expert or by a computer program based on a technique called process mining Any deviation from such a “perfect” schema is considered as an exception. This approach works when processes are highly repetitive, usually orchestrated by a computer program, and a perfect schema is actually possible for the particular process type. However for many business processes such perfectly defined schemas don't exist. For example, consider a process for treating a patient in a hospital. Whatever schema one defines, the vast majority of the patients will not follow it exactly. The sequence of doctor visits, exams, tests, procedures, payments, etc. is virtually unique for every patient due to human decision making and the tremendous variability of possible medical conditions. A schema with multiple conditions which is capable of describing such a process is extremely complex and not suitable for analysis especially by the business users that would best benefit from the analysis.

Logs/pattern analysis focuses on records or other data artifacts created as a result of the execution of the process activities and attempts to find distinct repetitive fragments. For example, it may find that the fragment A-B-C, where A, B and C are specific process activities, usually happens sometime after the fragment X-Y-Z. This method is widely used in web analytics and financial fraud prevention. However this method doesn't provide end-to-end analysis of the process nor any information about the quality and efficiency of the business process.

### SUMMARY OF THE INVENTION

The present invention provides a method of analyzing business processes without the need for defining the complete process schema. The method includes finding the plurality of unique paths through the process by converting the discrete facts from one or more systems of record into sequences of facts and then converting these sequences into unique paths. The method further includes the reduction of the number of unique paths by applying a plurality of merging rules. The embodiments of the present invention calculate a plurality of measures for the paths and display the paths and the related measures to the computer operator. The operator can dynamically change the merging rules and set the filters for the facts and the sequences and then repeat the path generation process.

### BRIEF DESCRIPTION OF THE DRAWING

FIG. 1 illustrates the analysis process and shows the main functional elements of the embodiment of the present invention.

FIG. 2 shows an example of the conversion process.

FIG. 3 illustrates how changes in the merging rules affect the generated paths.

FIG. 4 is an example of one embodiment of the system for displaying the paths and the related measures to a computer operator.

### DETAILED DESCRIPTION OF THE INVENTION

The present invention provides a method, implemented on a computer system, for the analysis of the operations of an organization. The following definitions are used in the description of the invention:
a) Activity is the name of the unit of work, such as “Fill in a form”, “Place an item into a cart” or “Order a test for an emergency room patient”
b) An activity has Attributes, for example, an activity “Order a test for a patient” could have the attributes Test type, Doctor, Patient, Urgency level, etc. A default attribute of any activity is the time when this activity occurs.
c) A Fact is the information stored in one of the systems of record indicating a particular activity has happened at a specific time with particular attributes values
d) A Sequence is the ordered list of facts which are connected to each other as one logical business process
e) Sequence attributes are a subset of the attributes of facts comprising a particular sequence
f) A Path is the unique ordered list of activities

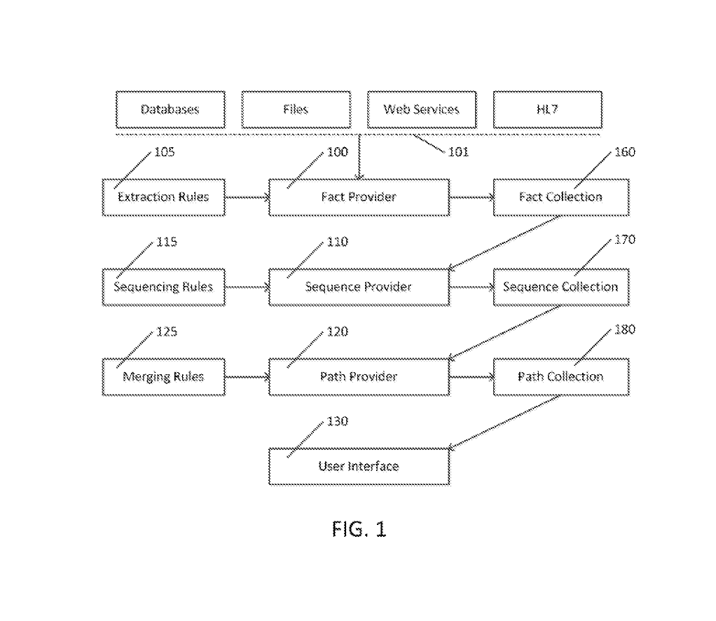

The preferred embodiment of the invention is a computer program comprising the following modules as shown in FIG. 1: Fact Provider 100, Sequence Provider 110, Path Provider 120 and User Interface 130.

The Fact Provider accesses the organizational systems of record 101, extracts the Facts using the Extraction Rules 105 and places them into the Fact Collection 160. Extraction rules describe a mechanism to identify and fetch the fact data from the systems of record. Depending on the nature of these systems, the extraction rules may include the database queries, web service interfaces, file parsing templates, or data interchange protocols such as, for example, HL7 or EDI.

A Fact Collection 160 is a set of records where each fact is represented by a single record. In one embodiment it can be implemented as a database table.

The Sequence Provider converts the collection of facts into the collection of the sequences 170 using Sequencing Rules 115. The sequencing rules describe the logical condition under which two facts belong to the same sequence and define which attributes of the facts should become the attributes of the sequence in order to distinguish one sequence from another. In one embodiment the rules are defined as a match between the values of the specified attributes of the facts thus if the values are equal, the facts belong to the same sequence.

Sequence collection 170 is a set of records where each sequence is represented by a single record that has the references to the facts which belong to this sequence. In one embodiment it can be implemented as two related database tables: one for the sequences and another for the facts belonging to the sequence with a many-to-many relation between them.

A Path Provider converts a collection of sequences 170 into a collection of paths 180 using Merging Rules 125. As described in further detail below, the merging rules define when several sequences belong to the same path. Once the collection of the Sequences which belongs to a given path is defined, the path provider calculates the measures related to this Path also described below.

A Path Visualizer, as described in further detail below, displays the path collection to the user, displays the measures for the paths, displays the sequences which belong to a given path, display the facts which belong to a given sequence and provides a user interface for the user to change the sequencing 115 and merging 125 rules and to filter out specific facts from fact collection 160 and sequences from sequence collection 170.

Once rules or collections are changed, sequence and path providers update the collections and the measures. A User Interface then displays the updated path collection and the measures.

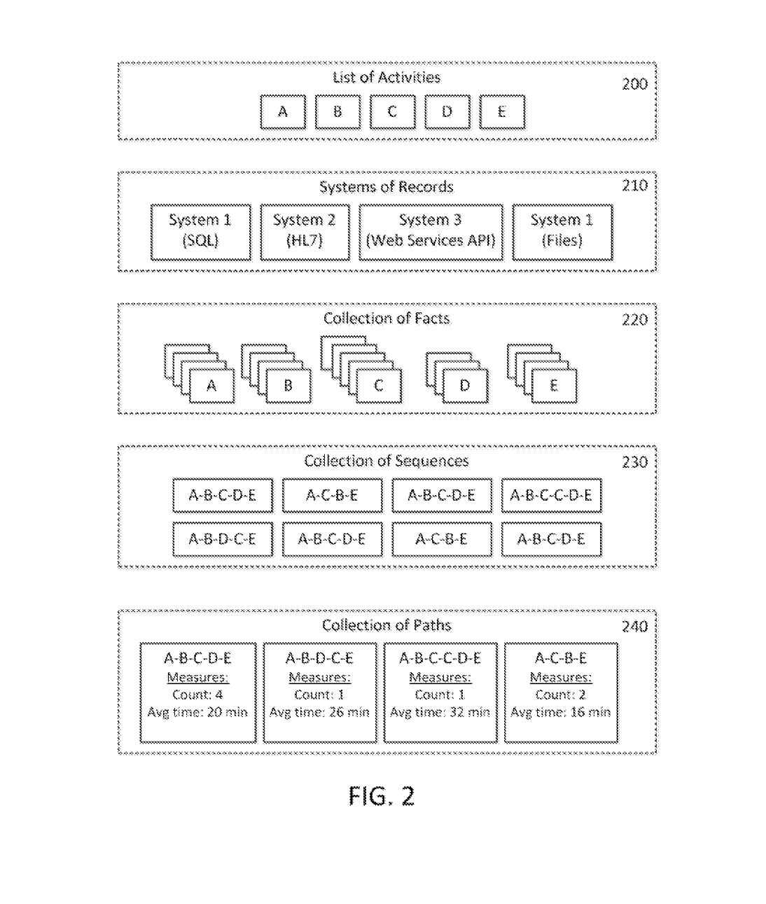

FIG. 2 provides an illustration of the method. Consider an organization having among others the activities 200 labeled A, B, C, D, E. When executed in the course of business operations, these activities create or update the data in the systems of record 210. These systems could be accessible through plurality of interfaces: SQL, HL7, Web Services, data files and others.

The fact provider accesses these systems and populates a collection of facts 220. Every fact has is linked to a specific activity, the time when this activity happened and any number of additional attributes of the activity.

The sequence provider applies sequencing rules to a collection of facts 220 and generates the sequences 230. The facts inside each sequence are ordered by the time they occurred. In one embodiment the sequencing rule is a simple match of the values of the specified attributes like: Facts A and B belong to the same sequence if the value of the attribute Al of the fact A is the same as the value of the attribute B1 of the fact B. Each sequence represents a particular instance of the business process or its fragment.

The path provider applies the merging rules to a collection of sequences 230 and populates a collection of paths 240. One embodiment of the invention has merging rules defined as: a sequence X belongs to the path Y if the activities of the facts in the sequence match the activities in the path within the allowed exceptions. One embodiment has the following types of allowed exceptions:
a) Activity X could be repeated multiple times
b) Activity X is optional and may be absent in the sequence
c) Activity X could happen anywhere in the sequence
d) Activity X should be excluded from the sequence
e) Activities X, Y, Z are executed in parallel therefore their order in a sequence should not be used in matching process
f) If in some sequence the time between a fact related to the activity X and a fact related to the activity Y is less than the time threshold Z, the order of these facts in the sequence could be changed so fact X is placed before fact Y in the sequence regardless of their actual occurrence

For each path from a path collection a plurality of measures is defined. One embodiment of the invention includes the following measures:
a) The number of the sequences belonging to a path
b) The average, median, 75 and 90 percentile, minimum and maximum times between the first and the last facts in the sequences belonging to a path
c) The ratio of the number of sequences belonging to a path to the total number of the sequences
d) The sum and average values of the numeric attributes or an arithmetic expression based on the attributes of the activities included in a path and calculated for all sequences belonging to the path

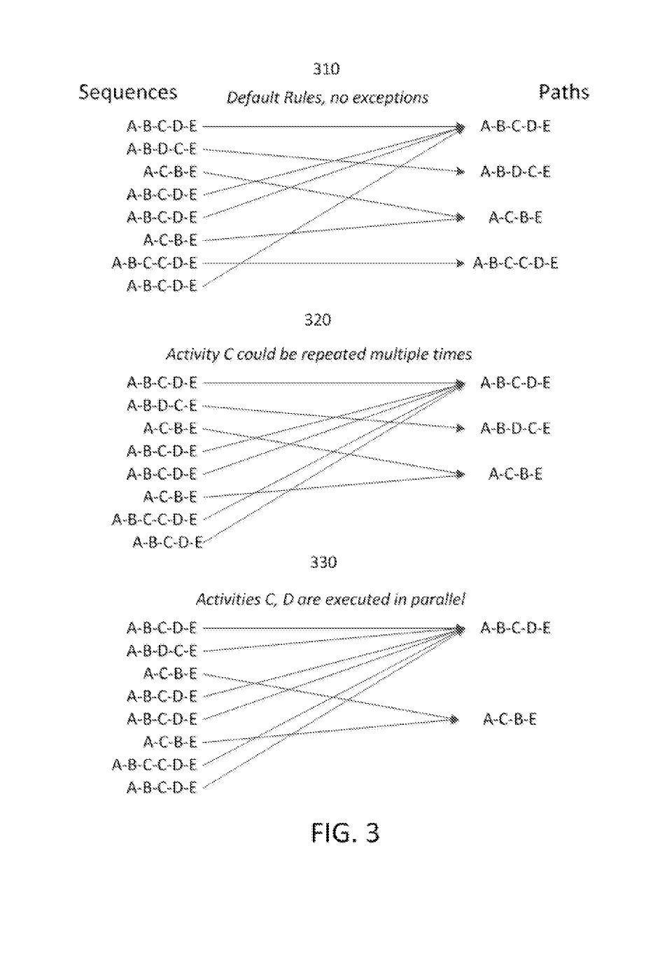

FIG. 3 illustrates how the merging rules change the outcome of the path Provider. The first set of paths 310 is produced using the default merging rules with no exceptions. The outcome has four paths.

Once the exception “activity C could be repeated multiple times” is included, the sequence A-B-C-C-D-E is merged into the same path as the sequence A-B-C-D-E and therefore the number of paths reduces to three.

If the exception “Activities C, D are executed in parallel” is also included, A-B-D-C-E is merged into the same path as the sequence A-B-C-D-E.

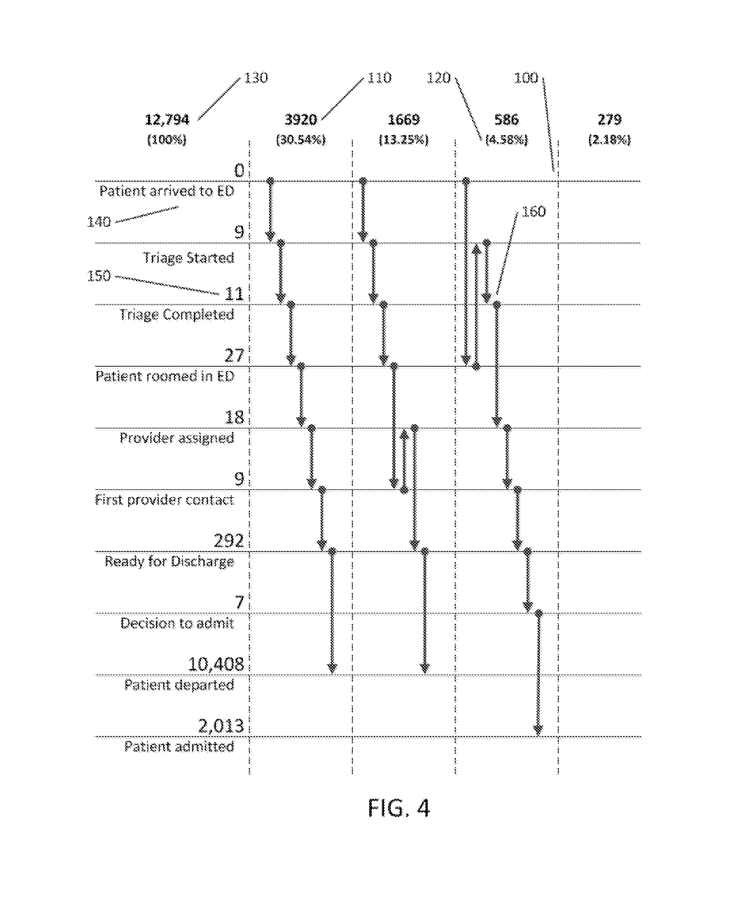

Once the plurality of paths is constructed, it is displayed to the computer operator. FIG. 4 shows one embodiment of the Visualizer module. In this embodiment each path is displayed as a column 100. The column represents the order of activities 160 shown as the connections between the activities 140.

In one embodiment the system shows the measures “Number of sequences belonging to a path” 110 and “Ratio of the number of the sequences belonging to a path to the total number of the sequences” 120. The system also shows the total number of sequences 130 covered by the analysis. The columns representing the paths are ordered by the values of the associated measures.

One embodiment also shows a number of sequences 150 with the last fact of a sequence belonging to the particular activity.

In one embodiment, the computer operator can select the particular path and the system displays the plurality of sequences belonging to this path. Then the operator can select a particular sequence and the system displays the facts comprising this sequence.

Operator further reduce the number of unique paths by filtering the paths, sequences and facts using Graphical User Interface. In one embodiment of the invention the filtering options include:
a) The paths can be filtered by the presence or absence of a specific activity and by the range of the values for the measures
b) In addition to that, the sequences can be filtered by the values of the sequence attributes and by the timing between the the specific facts in the sequence:
   a. Time since the first fact in the sequence
   b. Time since the last fact in the sequence
   c. Time between any two facts in the sequence
c) The facts are filtered by the values of the attributes and by the activity which a fact represents.

Once facts or sequences are filtered, the process described in FIG. 1 is repeated to generate a new collection of paths and related measures.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of analyzing the facts related the operations of an organization, the method comprising:
selecting at least two organization activities to be analyzed; and
extracting a plurality of facts related to these activities from one or more systems of record; and
converting these facts into at least one sequence; and
converting these sequences into at least one path; and
visualizing these paths for the human operator; and
using the operator's input to modify the sequences, paths and visualization.

2. A method in accordance with claim 1, wherein the conversion of the facts into sequences is performed by the plurality of configurable sequencing rules based on the fact attributes.

3. A method in accordance with claim 1, wherein converting the sequences into paths is based on a plurality of configurable merging rules

4. A method in accordance with claim 3, wherein a plurality of measures is calculated for each path.

5. A method in accordance with claim 1, further comprising displaying the paths and related measures for the computer operator.

6. A method in accordance with claim 5, further comprising displaying the sequences which were merged to a selected path and the facts which were combined into the selected sequence.

7. A method in accordance with claim 1, wherein the operator can change the sequencing and merging rules and repeat the process of converting the facts into sequences and sequences into the paths.
